(19) United States
(12) Patent Application Publication
(10) Pub. No.: US 2014/0115797 A1
(43) Pub. Date: May 1, 2014

(54) SELF-DRIVEN FLOOR CLEANING DEVICE

(71) Applicant: Alfred Kärcher GmbH & Co. KG, Winnenden (DE)

(72) Inventor: Markus Duenne, Winnenden (DE)

(73) Assignee: Alfred Kärcher GmbH & Co. KG, Winnenden (DE)

(21) Appl. No.: 14/149,181

(22) Filed: Jan. 7, 2014

Related U.S. Application Data
(63) Continuation of application No. PCT/EP2012/063551, filed on Jul. 11, 2012.

(30) Foreign Application Priority Data
Jul. 11, 2011 (DE) 102011051729.4

(51) Int. Cl. A47L 11/24

(52) U.S. Cl. CPC A47L 11/24
USPC 15/3

(57) ABSTRACT

A self-driven floor cleaning device is provided, including a chassis with a center plane oriented parallel to a forward direction of travel and on which a front end of the floor cleaning device is arranged, wherein the front end is the furthest forward projecting end; and an optical sensor mechanism arranged on the chassis, which includes a first transceiver unit arranged to the left of the center plane and having a first detection field crossing the center plane in front of the front end and directed to the front right; a second transceiver unit arranged to the right of the center plane and having a second detection field crossing the center plane in front of the front end and directed to the front left; and a crossing region spaced between 0.8 and 6 cm from the front end, at which the first and/or second detection field cross the center plane.

### CROSS-REFERENCE TO RELATED APPLICATIONS

The present application is a continuation of international application number PCT/EP2012/063551, filed on Jul. 11, 2012, which claims the benefit of German application number 10 2011 051 729.4, filed on Jul. 11, 2011, the entire specification of both being incorporated herein by reference.

### BACKGROUND OF THE INVENTION

The invention relates to a self-driven floor cleaning device, comprising a chassis with a center plane, which is oriented parallel to a forward straight-ahead direction of travel and on which a front end of the floor cleaning device in relation to the forward straight-ahead direction of travel is arranged or formed, the front end being an end of the floor cleaning device which projects forward the furthest, and to an optical sensor mechanism, which is arranged on the chassis.

A self-driven floor cleaning device is known from DE 10 2004 004 505 A1, which is self-controlling, with a floor treatment unit, a drive unit and a control unit to control the movement, at least one sensing device being associated with the control unit to detect obstacles and it being possible to predetermine for the control unit at least one movement pattern for travelling on the floor surface to be treated. The floor treatment device has sensors for detecting the outer contour of the floor surface. By means of the control unit, the floor surface can be segmented into partial segments and the partial segments can be travelled over and treated consecutively with the aid of a predetermined movement pattern. The floor treatment device comprises a locating member for determining the position of the floor treatment device with the aid of one or more reference points, which can be determined from the sensor data of the sensors detecting the outer contour.

A floor treatment device with at least one detection unit for generating images of the floor surface, which is to be treated, at consecutive instants during the movement of the floor treatment device is known from the not-prior-published DE 10 2010 029 241.9 of May 21, 2010 of the same Applicant, it being possible to produce a map of the floor surface using the images. It can be determined by the floor treatment device whether the floor surface has a basic pattern that is regularly repeated, whether the floor surface segment having the basic pattern can be identified by the floor cleaning device as to be treated and the floor treatment device comprises a memory element to store a region associated with a floor surface segment to be treated in the map.

A floor cleaning device, which is self-driven and self-steering and comprises a drive unit, a floor cleaning unit and a control unit for controlling the movement, is known from the not-prior-published DE 10 2010 029 238.9 of May 21, 2010 of the same Applicant, the control unit having a communication member for coupling the floor cleaning device to an external operating unit by means of a communication network, by means of which instructions from an operator can be transmitted to the operating unit to control the floor cleaning device. The floor cleaning device comprises a camera unit associated with the control unit for generating images of a floor surface to be cleaned, which images can be transmitted by means of the communication member by way of the communication network to the operating unit. The floor surface can be cleaned as the result of an instruction from the operator using a cleaning program that can be predetermined.

A cleaning robot comprising sensors is known from U.S. Pat. No. 7,805,220 B2.

A mobile cleaning robot comprising a wall sensor to detect a wall in a space is known from US 2010/0263142 A1.

A self-driven floor cleaning vehicle equipped with two ultrasonic sensors directed in the direction of travel is known from DE 196 15 712 C2.

A self-driven work robot having a first distance sensor to measure a spacing to an obstacle in a front direction of the robot, and comprising a second distance sensor for measuring a distance to an obstacle in a diagonal forward direction of the robot is known from US 2007/0032904 A1.

An autonomous mobile robot cleaner having movement distance detection means and movement direction detection means is known from US 2005/0171644 A1.

A robot having an infrared sensor is known from US 2004/0220698 A1.

A robot cleaner, which wirelessly communicates with an external device, is known from US 2002/0153185 A1.

A system for navigation referencing within a predetermined space is known from U.S. Pat. No. 5,276,618.

A crash-proof autonomous travel system with limiting marks is known from WO 00/25186.

### SUMMARY OF THE INVENTION

In accordance with the invention, a self-driven floor cleaning device is provided, which allows effective and, in particular, automated floor cleaning.

In accordance with an embodiment of the invention, the optical sensor mechanism has a first transceiver unit, which is arranged to the left of the center plane in relation to the forward straight-ahead direction of travel and has a first detection field, which crosses the center plane in front of the front end and is directed to the front right, and has at least one second transceiver unit, which is arranged to the right of the center plane and has a second detection field, which crosses the center plane in front of the front end and is directed to the front left, a crossing region, at which the first detection field and/or the second detection field cross the center plane, having a spacing in a range between 0.8 cm and 6 cm and in particular in a range between 1 cm and 5 cm with respect to the front end of the floor cleaning device.

The optical sensor mechanism of a self-driven floor cleaning device according to the invention has a field of view, which comprises both a region in front of the front end of the floor cleaning device and also an edge region to the left and right of an extension to the front of the left-hand side or right-hand side of the floor cleaning device respectively.

As a result, a wall or corner may, for example, be detected, or objects can be detected in the region in front of the front end. This makes it possible to move up to a wall or an object and, for example, also to “gently” strike against it. The relative position of the floor cleaning device in relation to the object is known owing to corresponding sensor signals of the optical sensor mechanism and this can be used to move up to the object. If the object is struck, the spacing from the object (such as, for example, a wall or a chair leg) can be minimized. This produces an optimized cleaning result in front of the object.

The optical sensor mechanism can be configured in a simple manner.

The front end of the floor cleaning device is, in particular, an end of the floor cleaning device, which projects forward the furthest (in relation to the forward straight-ahead travel direction). The center plane of the chassis is, in particular, a plane of symmetry for the chassis, a rotational axis, for example, of an (unsteered) wheel mechanism, which is arranged on the chassis, being oriented perpendicularly to the center plane.

It is favorable if the first detection field and the second detection field at least approximately intersect on the center plane. This produces a symmetrical field of view with an optimized object detection in the region in front of the front end of the floor cleaning device.

It is quite particularly advantageous if the first transceiver unit and the second transceiver unit are arranged at least approximately symmetrically with respect to the center plane and, in particular, arranged at the same distance from the center plane. As a result, a symmetrical field of view is produced, and therefore an optimized detectability of objects. Both objects in front of the front end of the floor cleaning device and objects at edge regions to the left and right of the extension can be detected by corresponding sides of the floor cleaning device.

It is favorable if the optical sensor mechanism is arranged at or close to the front end. As a result, an optimized field of view is produced to the front and also to the side. A shadowing of the field of view can easily be avoided.

It is favorable if the first transceiver unit and the second transceiver unit in each case have a transmitter for optical transmitted light and a receiver for received light, received light comprising transmitted light reflected at an object. The received light can also comprise scattered light and the like, which is not used, in particular for the evaluation. An optimized distance measurement can thereby easily be carried out in particular by means of triangulation.

It is quite particularly advantageous if the first detection field extends beyond an (imaginary) extension of a right-hand side of the floor cleaning device and beyond the front end of the floor cleaning device. The right-hand side is that side of the floor cleaning device, which is located on the right in relation to the forward straight-ahead direction of travel and has the point here having the greatest spacing from the center plane. If the first detection field extends beyond this extension of the right-hand side, an object positioned next to the floor cleaning device can be detected. As a result, for example, a wall can be followed. If the first detection field extends beyond the front end of the floor cleaning device, an object can be detected which is located in front of the front end of the floor cleaning device (in relation to the forward straight-ahead travel direction).

For the same reason it is favorable if the second detection field extends beyond an (imaginary) extension of a left-hand side of the floor cleaning device and beyond the front end of the floor cleaning device. By overlaying the first detection field and the second detection field in the region in front of the front end of the floor cleaning device, an enlarged region is produced for object detection in front of the front end of the floor cleaning device.

It has proven to be advantageous if a crossing region, at which the first detection field and/or the second detection field cross the center plane, has a spacing in the range between 0.8 cm and 6 cm and, in particular, between 1 cm and 5 cm from the front end of the floor cleaning device. At typical speeds of the self-driven floor cleaning device, a timely braking can still be achieved in front of an object if such an object is detected. As a result, an impact against the object can be avoided or a “gentle” impact can take place, in which the speed is below a predetermined speed threshold.

It is favorable if a main direction of the first detection field and/or the second detection field are at an angle in the range between 10° and 45° and, in particular, in the range between 15° and 35° with respect to a perpendicular to the center plane. A good object detection can be carried out by means of a flat acute angle, which is below (and including) 45°. The angle is about 18° in one embodiment.

In one embodiment it is provided that the first transceiver unit is located closer to a left-hand side of the floor cleaning device than to the center plane. As a result, a small angle can be realised for a main direction of the detection field and objects located in front of the front end of the floor cleaning device can be detected early.

For the same reason it is favorable if the second transceiver unit is located closer to a right-hand side of the floor cleaning device than to the center plane.

Alternatively, it is possible for the first transceiver unit to be located closer to the center plane than to a left-had side of the floor cleaning device. As a result, an edge region (in relation to an extension of the left-hand side of the floor cleaning device) can be detected well.

For the same reason it is favorable if the second transceiver unit is located closer to the center plane than to a right-hand side of the floor cleaning device.

The aforementioned arrangements of the first transceiver unit and the second transceiver unit can also be combined if more than two transceiver units are provided. For example, a first transceiver unit and a second transceiver unit are provided, which are located closer to outsides (left-hand side and right-hand side) than to the center plane. A third transceiver unit and a fourth transceiver unit are provided, which are then located closer to the center plane. As a result, an early object detection can be carried out for the region in front of the front end and good edge region detectability can be achieved.

In one embodiment, a spacing between the first transceiver unit and the second transceiver unit is greater than or equal to a spacing between the first transceiver unit and a closest outside of the floor cleaning device and/or a spacing between the second transceiver unit and a closest outside of the floor cleaning device. As a result, in particular, objects can be detected early if they are located in the region in front of the front end of the floor cleaning device.

For example, the optical sensor mechanism carries out a distance measurement. This distance measurement takes place, for example, by triangulation.

The distance measurement is advantageously clocked with respect to time. For example, a cycle time is below 20 ms. As a result, a good time resolution can be achieved to control the drive operation of the floor cleaning device.

A brush mechanism is advantageously arranged at or close to the front end. Dirt is entrained by the brush mechanism in order to obtain an optimized cleaning result.

It is favorable if the optical sensor mechanism is arranged above the brush mechanism relative to the direction of gravity. As a result, the outer dimensions of the self-driven floor cleaning device can be kept small. This also means that the optical sensor mechanism does not project, for example, beyond the front end, in order to prevent damage to the optical sensor device in the event of an impact.

The self-driven floor cleaning device is configured, in particular, as a cleaning robot and, in particular, a suction robot. The self-driven floor cleaning device is then also self-controlling and self-steering and an automatic cleaning process can be carried out.

In particular, a control mechanism is provided, which has an effective signal connection to the optical sensor mechanism and which controls a drive operation of the floor cleaning device depending on sensor signals. The sensor signals provided by the optical sensor mechanism can then be used to optimize the drive operation of the floor cleaning device.

In particular, the control mechanism comprises at least one of the following sub-units: a braking device, by means of which a speed of the floor cleaning device can be reduced, controlled by an object detection by means of sensor signals, an object detection mechanism, by means of which the type and/or orientation of an object can be detected, a station detection mechanism, by which a floor station for the floor cleaning device can be detected. When an object is detected, an impact or hard impact against the object can be prevented by a braking mechanism. This in turn allows an object to be very closely approached. If, for example, the braking mechanism ensures that the speed of the floor cleaning device is lowered below a predetermined maximum speed threshold, the floor cleaning device can move up to the object with a minimized spacing and, in particular, strike against this “softly”. Damage to the object is thus avoided, it being possible to achieve an optimized cleaning result around the object. It can be detected, for example, by the object detection mechanism whether a corner or a wall is present. While passing by, for example, it can also be detected whether a chair leg or table leg is present. By means of the station detection mechanism, the position of the floor station can be detected, for example, by means of following the wall, or the position of the floor station can be detected directly by means of the optical sensor mechanism.

In one embodiment, a floor cleaning system is formed, which comprises (at least) one floor cleaning device and (at least) one associated floor station. The floor station is, in particular, provided with an optically detectable detection pattern. The self-driven floor cleaning device can then directly detect the floor station by means of the optical sensor mechanism.

A wheel mechanism is advantageously arranged on the chassis. The wheel mechanism comprises one or more driven wheels for the self-driven construction of the floor cleaning device. In particular, a rotational axis of the wheel mechanism is oriented perpendicularly to the center plane.

Advantageously, the first detection field and the second detection field are each of lobe form.

The following description of preferred embodiments is used to describe the invention in more detail in conjunction with the drawings.

### BRIEF DESCRIPTION OF THE DRAWINGS

FIG. 1 shows a schematic side view of an embodiment of a self-driven floor cleaning device with a floor station;

FIG. 2 shows a partial sectional view along the line 2-2 according to FIG. 1 in a first embodiment; and

FIG. 3 shows a partial sectional view along the line 3-3 according to FIG. 1 in a second embodiment.

### DETAILED DESCRIPTION OF THE INVENTION

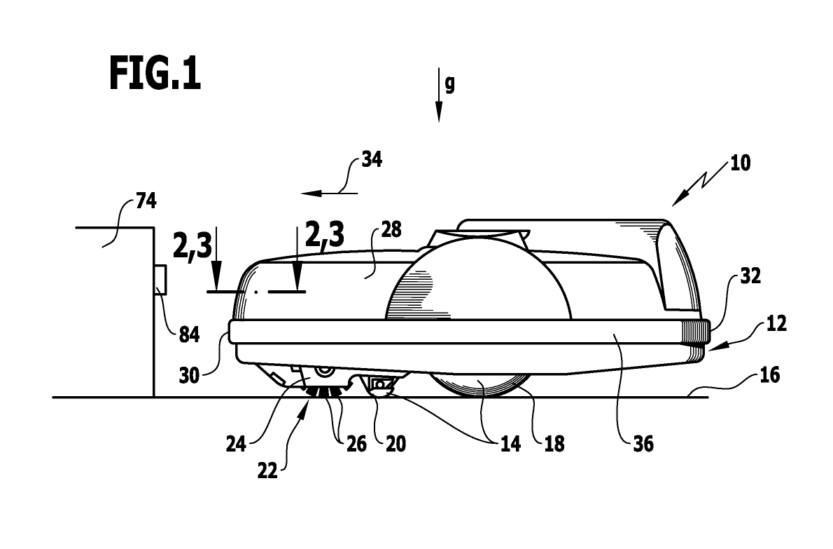

An embodiment of a self-driven floor cleaning device according to the invention, which is shown in FIG. 1 and designated 10 there, comprises a chassis 12. A wheel mechanism 14 is arranged as a whole on the chassis 12. The floor cleaning device 10 can travel on a floor 16 by means of the wheel mechanism 14.

The floor mechanism 14, for example, has driven main wheels 18. An electric motor (not shown in FIG. 1) is provided, for example, as a drive. Furthermore, the wheel mechanism 14 has one or more steerable wheels 20. A steering drive, which, in particular, comprises an electric motor (not shown in FIG. 1), is, in particular, associated with a steerable wheel of this type or steerable wheels 20 of this type.

A brush mechanism 22, which comprises one or more brush rollers 24, is arranged on the chassis 12. A brush roller 24, which is, in particular, rotatably arranged and, in particular rotatably arranged in a driven manner, comprises radially outwardly extending brushes 26, which can act on the floor 16. By rotating a brush roller 24, dirt is entrained, which is brought into a dirt container (not shown in FIG. 1) arranged on the chassis.

A housing 28, in which components of the floor cleaning device 10, such as drive motors, a dirt container, control mechanism etc. are arranged in a protected manner, is arranged on the chassis 12.

The floor cleaning device 10 has a front end 30 and a rear end 32 opposite the front end. The front end 30 is arranged or formed on the chassis 12. For example, it is formed on the housing 28. The same applies to the rear end 32.

The floor cleaning device 10 has a forward straight-ahead direction 34 of travel. In relation to the forward straight-ahead direction 34 of travel, the front end 30 is located at the front of the chassis 12 and the rear end 32 is arranged at the rear of the chassis 12. The front end 30 defines the region of the floor cleaning device 10 located the furthest forward, in relation to the forward straight-ahead travel direction.

The floor cleaning device 10 furthermore has a left-hand side 36 in relation to the forward straight-ahead direction 34 of travel (a plan view of this left-hand side 36 is shown in FIG. 1) and a right-hand side 38 (not visible in FIG. 1) opposite the left-hand side 36. Located on the left-hand side 36 and the right-hand side 38 are the regions of the floor cleaning device 10 located furthest to the outside in relation to a transverse direction to a connecting direction between the front end 30 and the rear end 32.

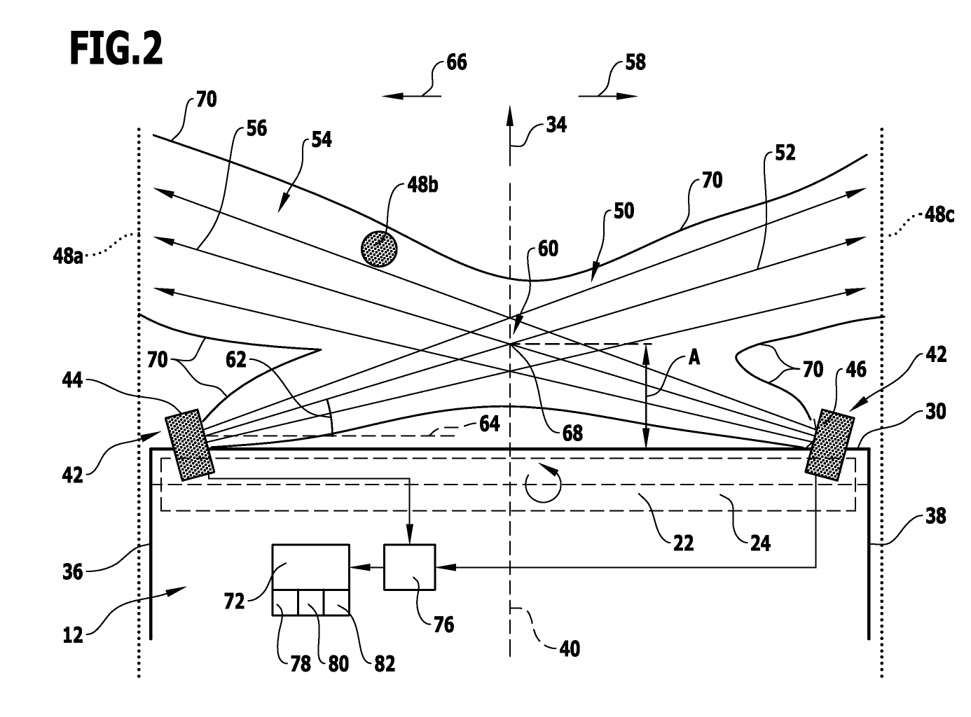

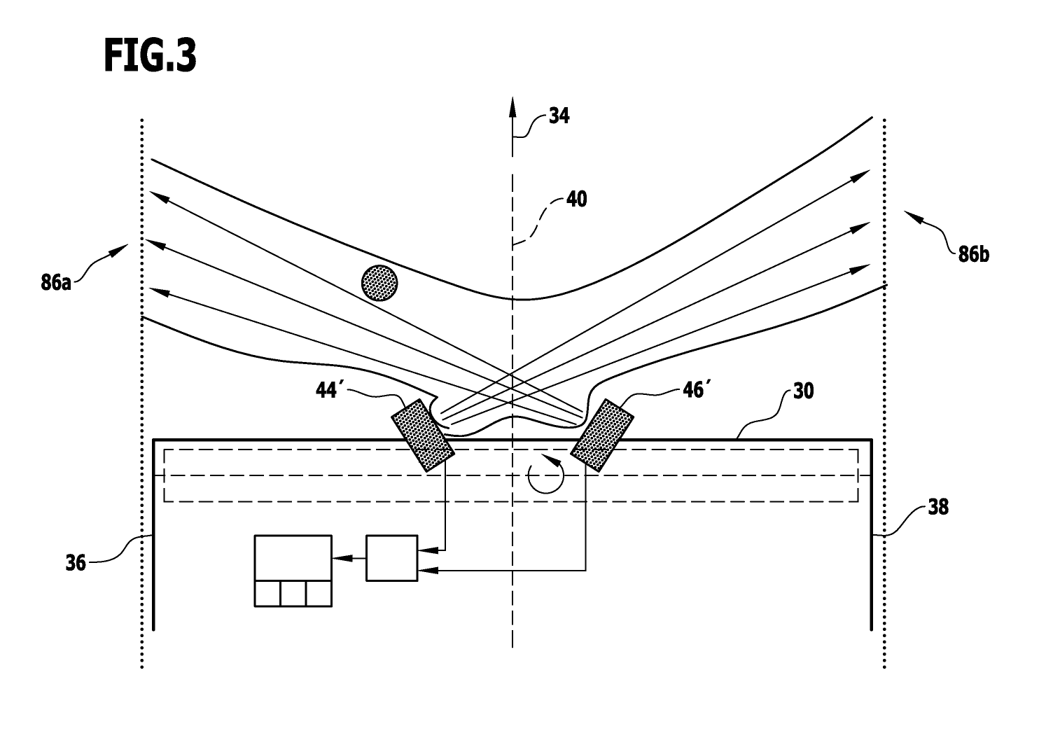

The chassis 12 defines a center plane 40 (cf. FIGS. 2 and 3), which is located centrally between the left-hand side 36 and the right-hand side 38. The forward straight-ahead direction 34 of travel is parallel to this center plane 40.

Arranged on the chassis 12 at or close to the front end 30 above the brush mechanism 22 in relation to the direction g of gravity is an optical sensor mechanism 42. This optical sensor mechanism 42 comprises a first transceiver unit 44 and (at least) one second transceiver unit 46. The first transceiver unit 44 and the second transceiver unit 46 are arranged on the chassis 12, in particular above the brush mechanism 22.

The first transceiver unit 44 and the second transceiver unit 46 in each case comprise a transmitter, which emits optical transmitted light (in particular in the infrared range), and a receiver for received light. The received light, which is evaluated, is transmitted light reflected by one or more objects 48a, 48b, 48c. Basically, scattered light etc. is also received by the receiver of the first transceiver unit 44 and the second transceiver unit 46. By means of corresponding devices such as filters, discriminators etc., receiver light that goes back to transmitted light, in other words reflected transmitted light, can be “filtered out” for further evaluation.

The first transceiver unit 44 and the second transceiver unit 46 may, for example, be realised by separate components for the transmitter and receiver, these components then being arranged correspondingly oriented with respect to one another. In an advantageous embodiment, the transmitter and receiver are integrated in a component, which can then be positioned as a whole on the chassis 12. An optical imaging mechanism and/or filter and the like are then advantageously also integrated in this component.

The first transceiver unit 44 has a first detection field 50. This first detection field 50 is determined by the radiation characteristic of the transmitter of the first transceiver unit 44. The first detection field 50 has, in particular, a lobe form. A corresponding “detection lobe” is, in particular, rotationally symmetrical with respect to a main direction 52. Accordingly, the second transceiver unit 46 has a second detection field 54, which is determined by the transmitted light of the transmitter of the second transceiver unit 46. This second detection field 54 has a main direction 56.

The first transceiver unit 44 is arranged between the center plane 40 and the left-hand side 36 on the chassis 12. The first detection field 50 is directed to the front right away from the front end 30 of the floor cleaning device 10. In FIG. 1, the direction to the right is indicated by the reference numeral 58. The first detection field 50 crosses (intersects) the center plane 40 (in its extension to the front) in a crossing region 60, which is located in front of the front end 30 of the floor cleaning device 10.

The main direction 52 of the first detection field 50 is located at an angle 62 to a perpendicular 64 to the center plane 40. The angle 62 is in a range here between 10° and 45° and, in particular, in a range between 15° and 35°.

The first detection field 50 is configured in such a way that it projects beyond the right-hand side 38 of the floor cleaning device 10, so objects 48c, which are positioned to the right of an extension of the right-hand side 38 of the floor cleaning device 10, can be detected. The corresponding configuration of the first detection field 50 takes place by means of the corresponding arrangement of the first transceiver unit 44 and also by predetermining a corresponding signal intensity of the transmitter of the first transceiver unit 44. Objects corresponding to the object 48b, which are located in front of the front end 30 of the floor cleaning device 10 (in front of the front end 30 and between extensions of the sides 36, 38) and fall within the first detection field 50, can also be detected. (In the example according to FIG. 2, the object 48b is not located in the first detection field 50 but in the second detection field 54.)

The second transceiver unit 46 is arranged between the center plane 40 and the right-hand side 38 of the floor cleaning device 10. It is arranged in such a way that the second detection field 54 is directed to the front left. The direction to the left is indicated by the reference numeral 66 in FIG. 2. The second detection field 54 is configured here (by the arrangement of the second transceiver unit 46 and by the corresponding signal intensity of the transmitter) in such a way that the second detection field 54 projects beyond the left-hand side 36 of the floor cleaning device 10 so that an object 48a to the left of the left-hand side 36 can also be detected. Furthermore, the second detection field 54 is directed to the front (in the direction of the forward straight-ahead direction 34 of travel).

The first transceiver unit 44 and the second transceiver unit 46 are preferably arranged symmetrically (in particular mirror symmetrically) with respect to the center plane 40. The first detection field 50 and the second detection field 54 are then also correspondingly symmetrical. The main direction 56 of the second detection field 54 is at an angle to the perpendicular 64, which, in terms of amount, corresponds to the angle 62 with an opposite orientation.

The second detection field 54 crosses (intersects) the center plane 40 in front of the front end 30 of the floor cleaning device 10 in the crossing region 60. The crossing regions, in which the first detection field 50 and the second detection field 54 cross the center plane 40, in particular coincide. The main direction 52 of the first detection field 50 and the main direction 56 of the second detection field 54 preferably cross at a point 68, which is located on the center plane 40 in front of the front end 30.

The first transceiver unit 44 and the second transceiver unit 46 preferably have the same distance from the center plane 40. The first transceiver unit 44 and the second transceiver unit 46 are located on a line, which is parallel to the perpendicular 64.

The point 68, at which the main directions 52 and 56 intersect, in a preferred embodiment, has a spacing A of between 0.8 cm and 6 cm and in particular a spacing in a range between 1 cm and 5 cm from the front end 30 of the floor cleaning device 10.

A field of view 70 of the optical sensor mechanism 42 is composed of an overlay of the first detection field 50 and the second detection field 54. This field of view 70 is configured in such a way that objects 48b, which are located within the field of view 70 in front of the front end 30 of the floor cleaning device 10, can be detected. Furthermore, objects 48a, 48c, such as, for example, walls or other items, which are located to the left and/or right of this floor cleaning device 10, can be detected.

The floor cleaning device 10 comprises a control mechanism 72, which controls a drive operation of the floor device 10. The floor cleaning device 10 is, in particular, configured as a self-controlling robot, which automatically carries out cleaning processes. The control mechanism 72 controls a drive operation in such a way that a preferably uninterrupted surface cleaning is carried out. Furthermore, the control mechanism 72 controls the floor cleaning device 10 in such a way that it returns to a floor station 74 (CF. FIG. 1), if, for example, storage batteries of the floor cleaning device 10 have to be recharged or a suction container has to be emptied.

The control mechanism 72 has an effective signal connection to the optical sensor mechanism 42; the optical sensor mechanism 42 provides the control mechanism 72 with sensor signals, by means of which the drive operation is controlled.

In one embodiment, there is associated with the optical sensor mechanism 42 an evaluation mechanism 76, which, in particular, receives analogue sensor signals from the first transceiver unit 44 and the second transceiver unit 46 and thus evaluates them and, in particular, provides digital signals, which can be directly processed by the control mechanism 72. It is also possible for the evaluation mechanism 76 to be integrated in the control mechanism 72.

The control mechanism 72 comprises a sub-unit, which is a braking mechanism 78. In particular if an object is detected in front of the front end 30 (such as, by way of example, the object 48b in FIG. 2), the control mechanism 72 ensures a reduction of the speed of the travelling floor cleaning device 10; the signals of the optical sensor mechanism 42 lead to a braking. The braking is, for example, such that the floor cleaning device 10 does not strike “in a hard manner” but “softly” against an object such as the object 48b, in other words strikes at most at a speed below a predetermined speed threshold.

The spacing A is selected such that depending on a maximum speed of the floor cleaning device 10 upon detection of a corresponding object, a soft impact is made possible, in other words, upon detection, sufficient time still remains for braking to below the speed threshold.

For optimum surface cleaning it is advantageous if the floor cleaning device 10 strikes “gently” against an object 48b and does not avoid the object in order to prevent an accumulation of dirt around the object.

The control mechanism 72, as a further sub-unit, comprises an object detection mechanism 80. The type and/or orientation of an object can be detected by this object detection mechanism 80. For example, it can be detected whether a wall or a corner is present. For example, it can be detected how a wall is oriented in relation to the chassis and, in particular, the center plane 40. It can also, for example, be detected while travelling past, what type of object it is. For example, it can be detected while travelling past whether a chair leg is present.

The control mechanism 72, as a further sub-unit, has a station detection mechanism 52. This allows the floor station 74 to be optically detected directly and/or indirectly. For example, the floor station 74 is provided with an optically detectable detection pattern 84 (cf. FIG. 1), which can be detected by means of the optical sensor mechanism 42. As a result, a journey to the floor station 74 can take place in a directly controlled manner. Alternatively or in addition it is possible for the position of the floor station 74 in relation to the current position of the floor cleaning device 10 to be detected by means of the station detection mechanism 82 in that, for example, a wall is followed, for example, by means of the optical sensor mechanism 42 (in particular in combination with the object detection mechanism 80) and for the corresponding data to be used alone or to assist the following of a travelling path in order to allow a return journey to the floor station 74.

The optical sensor mechanism 42 measures the spacing of the optical sensor mechanism 42 (and therefore the front end 30) from one or more objects. A clocked measurement takes place, in particular, in which measured values are delivered at specific time intervals. It is, for example, possible here for the transmitted light to be emitted in a pulsed manner and/or for a pulsed evaluation to take place. The distance measurement by means of the optical sensor mechanism 42 takes place, in particular, by triangulation. The corresponding clocking takes place in such a way that measurements take place at a time interval of less than 30 ms and, in particular, less than 20 ms. In one embodiment, the clocking for measured values is about 15 to 16 ms.

The configuration of the detection fields 50 and 54 as lobes are each shown in an exaggerated manner in FIG. 2. A typical angle for the lobe formation in relation to the main directions 52 and 56 is about 1° to 2°.

In FIGS. 2 (and 3), for illustrative reasons, the first transceiver unit 44, 44′ and the second transceiver unit 46, 46′ are drawn projecting beyond the front end 30. In practice, it is advantageous if these are set back relative to the front end, so that when the front end 30 strikes against an object (such as the object 48b) no mechanical striking of the optical sensor mechanism 42 against the object takes place.

The distance determination by means of the optical sensor mechanism 42 preferably takes place independently of color by means of infrared light.

Basically, the main directions 52, 56, in relation to the direction g of gravity, may be oriented horizontally; in the case of a flat horizontal floor 16, they are then oriented parallel to the floor 16. They may alternatively also be inclined downwardly, in other words at an acute angle with respect to the horizontal.

In the embodiment shown in FIG. 2, a spacing between the first transceiver unit 44 and the second transceiver unit 46 is greater than the spacing of the first transceiver unit 44 from the left-hand side 36 and the spacing of the second transceiver unit 46 from the right-hand side 38. The spacing of the first transceiver unit 44 and the second transceiver unit 46 from the center plane 40 is greater than the spacing of the corresponding transceiver unit 44 or 46 from the closest side, in other words from the left-hand side 36 in the first transceiver unit 44 and the right-hand side 38 in the second transceiver unit 46.

The first transceiver unit 44 is arranged in the region of a corner at the transition of the left-hand side 36 to the front end 30. The second transceiver unit 46 is arranged in a corner region at the transition between the right-hand side 38 and the front end 30. In a configuration of this type, a small angle 62 can be realised. As a result, objects such as the object 48b, which are located in front of the front end 30 of the floor cleaning device 10, are detected early.

In an alternative configuration, which is shown in FIG. 3, wherein for the same elements as in the embodiment according to FIG. 2, the same reference numerals are used, a spacing between the first transceiver unit 44′ and the second transceiver unit 46′ is smaller than the corresponding spacing from the associated left-hand side 36 (in the first transceiver unit 44′) or the right-hand side 38 (in the second transceiver unit 46′). The first transceiver unit 44′ is located closer to the center plane 40 than to the left-hand side 36. The second transceiver unit 46′ is located closer to the center plane 40 than to the right-hand side 38. As a result, an edge region 86a, 86b beyond the left-hand side 36 or right-hand side 38 of the floor cleaning device 10 can be detected well.

The floor cleaning device 10 according to the invention functions as follows:

Storage batteries of the floor cleaning device 10 are charged at the floor station 74 and a suction container can be emptied there. From the floor station 74, the floor cleaning device 10 carries out its cleaning journeys, in particular in an automated self-controlling manner (as a cleaning robot).

The journeys of the floor cleaning device 10 are controlled by the control mechanism 72, which comprises corresponding sub-units.

A spacing field of view 50 for the floor cleaning device 10, which may detect both a front region in front of the front end 30 and edge regions 86a, 86b to the left and right of the front region, is provided by the optical sensor mechanism 42. A wall can thus, in particular, be followed to control the journey of the floor cleaning device 10, specifically both for walls to the right of the right-hand side 38 and to the left of the left-hand side 36.

The floor cleaning device 10 can thus travel along a wall in a defined manner to optimize the cleaning result and to prevent streaks of dirt. Basically, a minimum spacing can thereby be achieved when travelling along a wall.

The floor cleaning device 10 can move up to a corresponding wall, it being possible for a gentle impact to take place.

Objects, such as, for example, an object 48b, can also be detected in the front region of the floor cleaning device 10. A precise approach to such an object 48b can in turn be achieved here with a soft impact in order to obtain an optimized cleaning result and for example, to prevent damage to the object or a rebound of the floor cleaning device 10. The optical sensor mechanism 42 can also be used to detect the floor station 74.

An optimized symmetrical field 70 of view is produced by a symmetrical arrangement of the first transceiver unit 44, 44′ and the second transceiver unit 46, 46′ in relation to the center plane 40.

The optical sensor mechanism 42, for example, provides analogue signals, which are evaluated in the evaluation mechanism 76 and converted into digital signals for further use by the control mechanism 72.

The optical sensor mechanism 42 can also comprise more than two transceiver units. For example, the embodiments according to FIGS. 2 and 3 may be combined in order to obtain both high edge region detectability and also to be able to detect objects early in front of the front end. In this case, for example, the transceiver units 44, 46 (cf. FIG. 2) are present as are the units 44′, 46′ (cf. FIG. 3) as third and fourth transceiver units.

### LIST OF REFERENCE NUMERALS

10 floor cleaning device
12 chassis
14 wheel mechanism
16 floor
18 main wheel
20 steerable wheel
22 brush mechanism
24 brush roller
26 brush
28 housing
30 front end
32 rear end
34 forward straight-ahead direction of travel
36 left-hand side
38 right-hand side
40 center plane
42 optical sensor mechanism
44, 44′ first transceiver unit
46, 46′ second transceiver unit
48a, 48b, 48c object
50 first detection field
52 main direction
54 second detection field
56 main direction
58 “to the right”
60 crossing region
62 angle
64 perpendicular
66 “to the left”
68 point
70 field of view
72 control mechanism
74 floor station
76 evaluation mechanism
78 braking mechanism
80 object detection mechanism
82 station detection mechanism
84 pattern
86a edge region
86b edge region

1. A self-driven floor cleaning device, comprising:
a chassis with a center plane, which is oriented parallel to a forward straight-ahead direction of travel and on which a front end of the floor cleaning device in relation to the forward straight-ahead direction of travel is arranged or formed, wherein the front end is an end of the floor cleaning device which projects forward the furthest; and
an optical sensor mechanism, which is arranged on the chassis;
wherein the optical sensor mechanism comprises:
a first transceiver unit, which, in relation to the forward straight-ahead direction of travel, is arranged to the left of the center plane and has a first detection field, which crosses the center plane in front of the front end and is directed to the front right, and
at least one second transceiver unit, which is arranged to the right of the center plane and has a second detection field, which crosses the center plane in front of the front end and is directed to the front left,
wherein a crossing region, at which at least one of the first detection field and the second detection field crosses the center plane, has a spacing in a range between 0.8 cm and 6 cm from the front end of the floor cleaning device.

2. The self-driven floor cleaning device according to claim 1, wherein the first detection field and the second detection field intersect at least approximately on the center plane.

3. The self-driven floor cleaning device according to claim 1, wherein the first transceiver unit and the second transceiver unit are arranged at least approximately symmetrically with respect to the center plane.

4. The self-driven floor cleaning device according to claim 1, wherein the optical sensor mechanism is arranged at or close to the front end.

5. The self-driven floor cleaning device according to claim 1, wherein the first transceiver unit and the second transceiver unit in each case have a transmitter for optical transmitted light and a receiver for received light, received light comprising transmitted light reflected at an object.

6. The self-driven floor cleaning device according to claim 1, wherein the first detection field extends beyond an extension of a right-hand side of the floor cleaning device and extends beyond the front end of the floor cleaning device.

7. The self-driven floor cleaning device according to claim 1, wherein the second detection field extends beyond an extension of a left-hand side of the floor cleaning device and beyond the front end of the floor cleaning device.

8. The self-driven floor cleaning device according to claim 1, wherein a main direction of at least one of the first detection field and the second detection field lies at an angle in the range between 10° and 45° with respect to a perpendicular to the center plane.

9. The self-driven floor cleaning device according to claim 1, wherein the first transceiver unit is located closer to a left-hand side of the floor cleaning device than to the center plane.

10. The self-driven floor cleaning device according to claim 1, wherein the second transceiver unit is located closer to a right-hand side of the floor cleaning device than to the center plane.

11. The self-driven floor cleaning device according to claim 1, wherein the first transceiver unit is located closer to the center plane than to a left-hand side of the floor cleaning device.

12. The self-driven floor cleaning device according to claim 1, wherein the second transceiver unit is located closer to the center plane than to a right-hand side of the floor cleaning device.

13. The self-driven floor cleaning device according to claim 1, wherein a spacing between the first transceiver unit and the second transceiver unit is greater than or equal to at least one of a spacing between the first transceiver unit and a closest exterior side of the floor cleaning device and a spacing between the second transceiver unit and a closest exterior side of the floor cleaning device.

14. The self-driven floor cleaning device according to claim 1, wherein the optical sensor mechanism carries out a distance measurement.

15. The self-driven floor cleaning device according to claim 14, wherein the distance measurement is clocked with respect to time.

16. The self-driven floor cleaning device according to claim 1, wherein a brush mechanism is arranged on or close to the front end.

17. The self-driven floor cleaning device according to claim 16, wherein the optical sensor mechanism is arranged above the brush mechanism in relation to the direction of gravity.

18. The self-driven floor cleaning device according to claim 1, said self-driven floor cleaning device being configured as a cleaning robot.

19. The self-driven floor cleaning device according to claim 1, said self-driven floor cleaning device comprising a control mechanism, which has an effective signal connection to the optical sensor mechanism and which controls a drive operation of the floor cleaning device depending on sensor signals.

20. The self-driven floor cleaning device according to claim 19, wherein the control mechanism comprises at least one of the following sub-units:
a braking mechanism for reducing a speed of the floor cleaning device, said braking mechanism being controlled by an object detection by means of sensor signals;
an object detection device for detecting at least one of the type and orientation of an object;
a station detection device for detecting a floor station for the floor cleaning device.

21. The self-driven floor cleaning device according to claim 1, said self-driven floor cleaning device comprising a floor station, which is provided with an optically detectable detection pattern.

22. The self-driven floor cleaning device according to claim 1, wherein a wheel mechanism is arranged on the chassis.

23. The self-driven floor cleaning device according to claim 1, wherein the first detection field and the second detection field are each of lobe form.
